(19) United States
(12) Patent Application Publication
(10) Pub. No.: US 2015/0106689 A1
(43) Pub. Date: Apr. 16, 2015

(54) WEB SERVER SYSTEM, WEB SERVER AND WEB PROVDING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LING-JUAN JIANG, Shenzhen (CN); CHIH-SAN CHIANG, New Taipei (TW); HUA-DONG CHENG, Shenzhen (CN)

(21) Appl. No.: 14/498,243

(22) Filed: Sep. 26, 2014

(30) Foreign Application Priority Data
Oct. 15, 2013 (CN) 2013104808840

(51) Int. Cl. G06F 17/21; G06F 17/22

(52) U.S. Cl. CPC G06F 17/212; G06F 17/2247
USPC 715/234

(57) ABSTRACT

A web server includes a terminal parameter obtaining module, a storage module, a web configuration module, a property determination module and a web loading module. The terminal parameter obtaining module obtains parameters of a display of a customer terminal when the customer terminal visits a web site. The storage module stores web resources corresponding to web sites. The web configuration module stores a relationship between parameters of displays, the web resources, and web configuration properties. The property determination module determines the web configuration property corresponding to the obtained parameter and the web resources. The web loading module loads the determined web configuration property to the web resource corresponding to form a web page. The disclosure also provided a web server system and a web providing method.

### BACKGROUND

1. Technical Field

The present disclosure relates to a web server system, a web server and a web providing method.

2. Description of the Related Art

Displays come in a number of different sizes. In order for web pages to be consistently displayed on all display sizes, a number of web pages including a same content are sometimes provided for the different display sizes. For example, a first web site links a personal computer (PC) version for displaying on a PC, a second web site links a mobile phone version for displaying on a mobile phone.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram block of a web serving system, according to an embodiment.

FIG. 2 is a flowchart of a web providing method.

### DETAILED DESCRIPTION

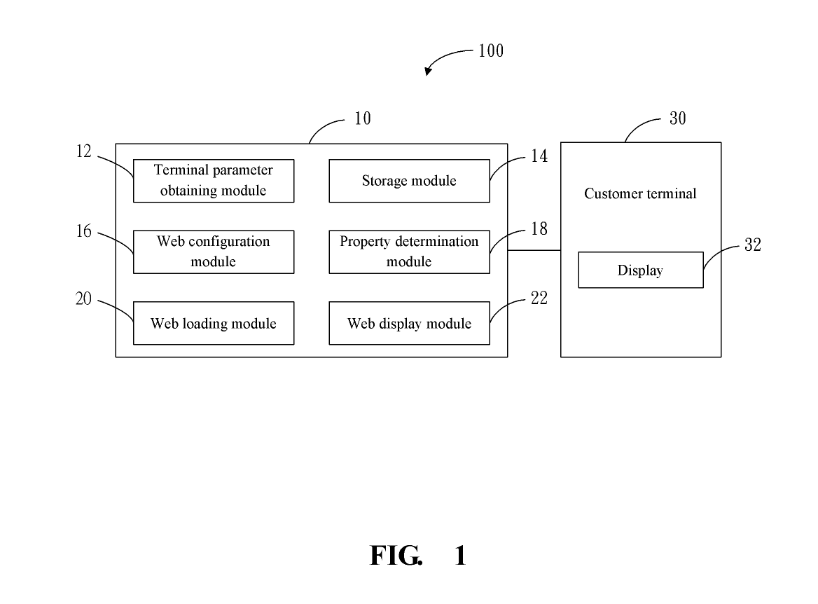

FIG. 1 illustrates a diagram block of a web serving system 100 according to an embodiment. The web serving system 100 is provided to a web server 10 or (and) a customer terminal 30 for providing a web service to the customer terminal 30. The web server system 100 is executed in a processor of the web server 10 or (and) the customer terminal 30. The web server system 100 includes a terminal parameter obtaining module 12, a storage module 14, a web configuration module 16, a property determination module 18, a web loading module 20 and a web display module 22. In the embodiment, the terminal parameter obtaining module 12, the storage module 14, the web configuration module 16, the property determination module 18, the web loading module 20 and the web display module 22 are all executed in the processor of the web server 10.

The terminal parameter obtaining module 12 is configured to obtain parameters of a display 32 of the customer terminal 30 when the customer terminal 30 visits a web site.

The storage module 14 is configured to store web resources corresponding to web sites. The web resources includes at least one data block, a number of data included in the data block and data types corresponding to the number of data forming a web. The data types includes a widget type, a text type and a image type. In the embodiment, the web resource is a Hypertext Markup Language (HML) file.

The web configuration module 16 is configured to store a relationship between parameters of displays, web resources and web configuration properties corresponding to the parameters of displays and the web resources. The web configuration properties include a web width. The web width is a preset width occupied by the web on the display 32 corresponding to a size of the display 32 when the web is displayed on the display 32. In the embodiment, when a size of the display 32 is smaller than or equal to a preset size, the web width is the size of the display 32. When the a size of the display 32 is larger than a preset size, the web width is the preset size. e.g., if the preset size is forty inches and the customer terminal 30 is a television with a display of sixty inches, comprises the web width of forty inches. Thus, less eye movement range along the display 32 is required when viewing the web page displayed on the display 32.

The web configuration properties further include a position information of each data block on the web page, a background information of each data block, a width and a length of each data included in each data block and a size of space between data. When the web resource includes a number of data blocks, the web configuration properties further include a size of space between data blocks. The display 32 having a small size is corresponding a small space between data blocks. The display 32 having a large size is corresponding to a large space between data blocks. Thus, an arrangement of the web is reasonable.

The property determination module 18 is configured to determine the web resource corresponding to the web site and the web configuration property according to the determined web resource, the obtained parameter and the relationship.

The web loading module 20 is configured to load the determined web configuration property to the web resource to form a web page.

The web display module 22 is configured to display the web page on the display 32 of the customer terminal 30.

In another embodiment, a part of the modules of the web serving system 100 are executed in the web server 10 and other part of the modules of the web serving system 100 are executed in the customer terminal 30. For example, the storage module 14 and the web configuration module 16 are executed in the web server 10. The terminal parameter obtaining module 12, the property determination module 18, the web loading module 20 and the web display module 22 are executed in the customer terminal 30.

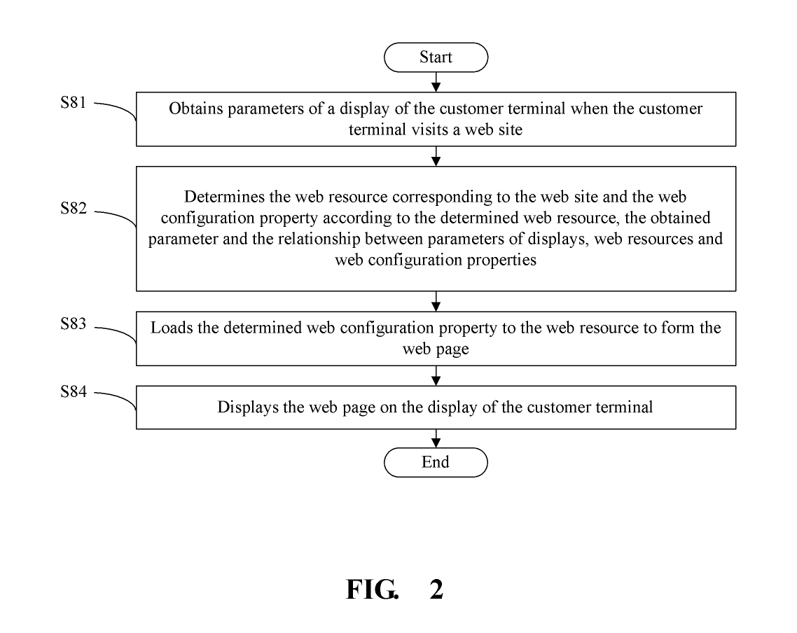

FIG. 2 illustrates a flowchart of a web providing method. The web providing method is employed the web server 10 or (and) the customer terminal 30 for providing a web page to the customer terminal 30.

In block S81, the terminal parameter obtaining module 12 obtains parameters of a display 32 of the customer terminal 30 when the customer terminal 30 visits a web site.

In block S82, the property determination module 18 determines the web resource corresponding to the web site and the web configuration property according to the determined web resource, the obtained parameter and the relationship between parameters of displays, web resources and web configuration properties.

In the embodiment, the web resources are stored in the storage module 14. The web resources include at least one data block, a number of data included in the data block and data types corresponding to the number of data comprising a web page. The data types include a widget type, a text type and a image type. In the embodiment, the web resource is a Hypertext Markup Language (HML) file.

The web configuration properties include a web width. The web width is a preset width occupied by a web page on the display 32 corresponding to a size of the display 32 when the web page is displayed on the display 32. In the embodiment, when a size of the display 32 is smaller than or equal to a preset size, the web width is the size of the display 32. When the a size of the display 32 is larger than a preset size, the web width is the preset size. The web configuration properties further include a position information of each data block on the web page, a background information of each data block, a width and a length of each data included in each data block and a size of space between data. When the web resource includes a number of data blocks, the web configuration properties further include a size of space between data blocks. The display 32 having a small size is corresponding to a small space between data block. The display 32 having a large size is corresponding to a large space between data blocks. Thus, an arrangement of the web is normal.

In block S83, the web loading module 20 loads the determined web configuration property to the web resource to form the web page.

In block S84, the web display module 22 displays the web page on the display 32 of the customer terminal 30.

The web serving system 100 and the web providing method provides the web page corresponding to the display of each customer terminals 30 when any customer terminal 30 visits the same web site.

It is understood that the present disclosure can be embodied in other forms without departing from the present disclosure. Thus, the present examples and embodiments are to be considered in all respects as illustrative, and the disclosure and following claims are not to be limited to the details given herein.

What is claimed is:

1. A web server for providing a web service to a customer terminal comprising:
a terminal parameter obtaining module configured to obtain parameters of a display of the customer terminal when the customer terminal visits a web site;
a storage module configured to store web resources corresponding to the web site, the web resources comprising a data block;
a web configuration module configured to store a relationship between parameters of displays, web resources, and web configuration properties corresponding to the parameters of displays and the web resources, the web configuration properties comprising a web width and a position information of the data block on the web page;
a property determination module configured to determine the web resource corresponding to the web site and to determine the web configuration property according to the determined web resource, the obtained parameter, and the relationship;
a web loading module configured to load the determined web configuration property to the web resource to form a web page; and
a processor configured to execute the terminal parameter obtaining module, the storage module, the web configuration module, the property determination module, and the web loading module.

2. The web server as claimed in claim 1, wherein when a size of the display is smaller than or equal to a preset size, the web width is the size of the display.

3. The web server as claimed in claim 1, wherein when a size of the display is larger than a preset size, the web width is the preset size.

4. The web server as claimed in claim 1, wherein the web resource comprises a plurality of data blocks, the web configuration properties further comprises a size of space between data blocks, the display having a small size is corresponding to a small space between data block, the display having a large size is corresponding to a large space between data blocks.

5. The web server as claimed in claim 1, further comprising a web display module, the web display module configured to display the web page on the display of the customer terminal.

6. A web providing method employed a web server or (and) a customer terminal for providing a web service to the customer terminal, the web providing method comprising:
obtaining parameters of a display of the customer terminal when the customer terminal visiting a web site;
determining a web resource corresponding to the web site and a web configuration property according to the determined web resource, the obtained parameter and a relationship between parameters of displays, web resources and web configuration properties, the web resources comprising a data block, the web configuration properties comprising a web width and a position information of the data block on the web page; and
loading the determined web configuration property to the web resource to form the web page.

7. The web providing method as claimed in claim 6, wherein when a size of the display is smaller than or equal to a preset size, the web width is the size of the display.

8. The web providing method as claimed in claim 6, wherein when the a size of the display is larger than a preset size, the web width is the preset size.

9. The web providing method as claimed in claim 6, wherein the web resource comprises a plurality of data blocks, the web configuration properties further comprises a size of space between data blocks, the display having a small size is corresponding to a small space between data block, the display having a large size is corresponding to a large space between data blocks.

10. The web providing method as claimed in claim 6, further comprising:
displaying the web page on the display of the customer terminal.

11. A web server system employed a web server or (and) a customer terminal for providing a web service to the customer terminal, the web server system comprising:
a terminal parameter obtaining module configured to obtain parameters of a display of the customer terminal when the customer terminal visits a web site;
a storage module configured to store web resources corresponding to the web site, the web resources comprising a data block;
a web configuration module configured to store a relationship between parameters of displays, web resources and web configuration properties corresponding to the parameters of displays and the web resources, the web configuration properties comprising a web width and a position information of the data block on the web page;
a property determination module configured to determine the web resource corresponding to the web site and the web configuration property according to the determined web resource, the obtained parameter and the relationship;
a web loading module configured to load the determined web configuration property to the web resource to form a web page; and
at least one processor comprised in the customer terminal or the web server, a part of modules comprising the terminal parameter obtaining module, the storage module, the web configuration module, the property determination module and the web loading module are executed in the at least one processor.

12. The web server system as claimed in claim 11, wherein when a size of the display is smaller than or equal to a preset size, the web width is the size of the display.

13. The web server system as claimed in claim 11, wherein when a size of the display is larger than a preset size, the web width is the preset size.

14. The web server system as claimed in claim 11, wherein the web resource comprises a plurality of data blocks, the web configuration properties further comprises a size of space between data blocks, the display having a small size is corresponding to a small space between data block, the display having a large size is corresponding to a large space between data blocks.

15. The web server system as claimed in claim 11, further comprising a web display module, the web display module configured to display the web page on the display of the customer terminal.
